(19) United States
(12) Patent Application Publication
(10) Pub. No.: US 2007/0285210 A1
(43) Pub. Date: Dec. 13, 2007

(54) Identification System

(75) Inventor: Mikael Willgert, Spanga (SE)

Correspondence Address: ALFRED J MANGELS, 4729 CORNELL ROAD, CINCINNATI, OH, 452412433, US

(73) Assignee: Tagmaster AB, Kista (SE)

(21) Appl. No.: 10/584,681

(22) PCT Filed: Dec. 7, 2004
(86) PCT No.: PCT/SE04/01818

§ 371 Date: Apr. 30, 2007

(30) Foreign Application Priority Data
Dec. 29, 2003 (SE) 0303551-6

(51) Int. Cl. G01S 13/02; G01S 13/76; H04B 1/59; H04Q 5/22

(52) U.S. Cl. 340/10.1

(57) ABSTRACT

A method and apparatus pertaining to identification systems in which a transponder reflects an inquiry signal from a communicator. The reflected signal is modulated with data that can be read by the communicator, and the data-carrying modulation includes a check sum calculated on the basis of data stored in the transponder memory. The transponder check sum is stored permanently in the transponder memory. A calculated check sum is calculated in the communicator based upon the transponder data included in the reflected inquiry signal, and the calculated check sum is compared with the check sum stored in the transponder to determine whether the transponder identifies an authorized person or object that is to be identified.

### BACKGROUND OF THE INVENTION

1. Field of the Invention

The present invention relates to a method pertaining to an identification system, and also to a transponder for an identification system.

2. Description of the Related Art

The invention is concerned with the control of access by individuals and authorized personnel in respect of companies, places that require authorized access, airports, places of interest and activity, such as arenas, and other places where an identification system is required.

Known automatic identification systems typically include individual-carried ID-tags, and ID-tag reading equipment.

Known automatic identification systems that use radio frequencies, so-called RFID (Radio Frequency IDentification), include at least one transponder and at least one communicator. A known type of transponder will include an antenna, a modulator, a memory, and a modulator-controlling logic circuit. One such known transponder is designed to be able to receive an output signal from the communicator and to reflect this signal in a modulated state. The communicator is designed to be able to receive and to read the signal reflected and modulated by the transponder.

An ID-tag that includes a transponder can be placed on an individual or on an object to be identified. Information contained in the transponder can be read by a communicator at a given short distance away, such as a distance of 5 meters for instance.

In order to enhance security and reliability in respect of the transmission of information from transponder to communicator there has been included a so-called check sum, which is calculated by a circuit in the transponder in accordance with an appropriate algorithm on the basis of data stored in the transponder. The check sum is transmitted from the transponder to the communicator in conjunction with the transmission of data.

A corresponding calculation on the basis of an algorithm takes place in the communicator subsequent to the communicator having received a signal that has been reflected and modulated by the transponder. A comparison is made between the check sums in the communicator.

One problem with the known technique described above is that calculation of the check sum requires an electronic circuit, which, in turn, requires energy, therewith increasing the cost of the transponder.

An object of the present invention is to provide a system which includes a transponder that has a low manufacturing cost and that has an energy consumption of such low magnitude as to obviate the need for the transponder to have its own battery.

The object identified above is achieved by means of the present invention.

### SUMMARY OF THE INVENTION

Briefly stated, the present invention relates to a method pertaining to an identification system in which a transponder reflects an inquiry signal from a communicator, wherein the reflected signal has been modulated with data that can be read by a communicator. The data-carrying modulation includes a check sum calculated on the basis of data stored in the transponder memory. In the present invention the check sum is permanently stored in the transponder memory.

The present invention also relates to a transponder that includes at least one antenna, at least one memory, and at least one means for reflecting and modulating an inquiry signal from a communicator. The reflected signal includes a data-carrying modulation, and the reflected signal can be read by a communicator. The data-carrying modulation includes a check sum calculated on the basis of data stored in the transponder memory. In the present invention the transponder includes a check sum that is permanently stored in the transponder memory.

### BRIEF DESCRIPTION OF THE DRAWING

The invention will now be described in more detail below, partly with reference to an exemplifying embodiment thereof illustrated in the accompanying drawing.

FIG. 1 is a schematic drawing in the form of a block diagram illustrating a transponder and a communicator in accordance with an embodiment of the present invention.

### DESCRIPTION OF THE PREFERRED EMBODIMENTS

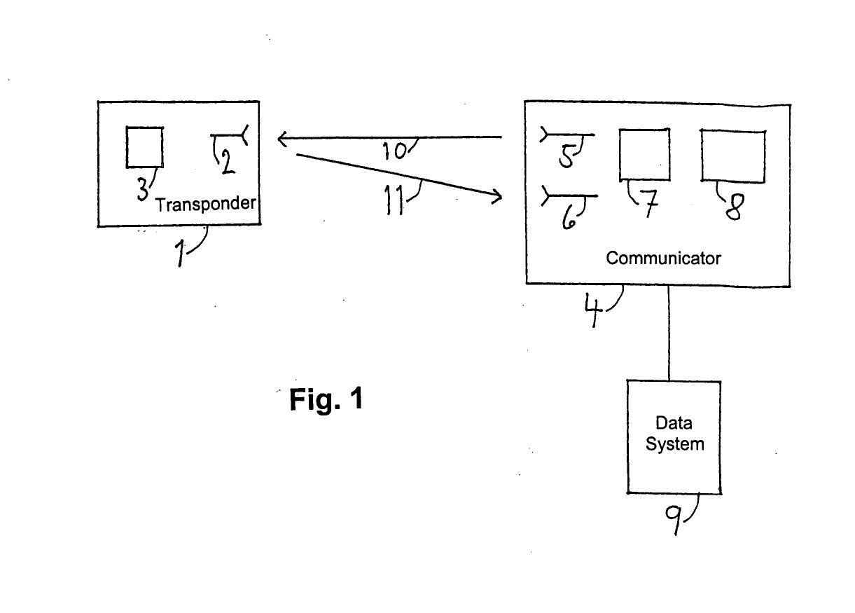

FIG. 1 shows a transponder 1 that includes an antenna 2 and a ROM-memory 3. Also shown in FIG. 1 is a communicator 4 with antennas 5, 6, a memory 7, a processor 8, and a data system 9. The inquiry signal 10 and the reflected, modulated response signal 11 are also shown in FIG. 1.

A preferred embodiment of the present invention resides in a method which includes calculating the check sum on the basis of an algorithm which is identical in respect of one group of transponders, and is different in respect of other groups of transponders.

A further preferred embodiment of the present invention resides in a method in which a calculation in accordance with the algorithm takes place in the communicator 4 each time a reflected signal 11 from transponder 1 is read, and in which the calculated check sum is compared with the stored check sum transmitted by the reflected signal 11.

In one preferred embodiment of the present invention there is included a transponder 1 which is characterized in that the stored check sum is calculated on the basis of an algorithm which is identical for one group of transponders and is different for other groups of transponders.

The identification system includes a communicator 4 which continuously transmits an inquiry signal 10. When a transponder 1 is in the close vicinity of a communicator 4, the signal 10 is received by the transponder antenna 2 and the signal 10 is then modulated to contain information and is reflected back to communicator 4. The reflected information includes data permanently stored in the transponder memory 3, particularly identification data concerning an object or an individual, and also a check sum that is also permanently stored in the transponder 1.

As opposed to earlier known techniques, the transponder check sum has already been calculated and stored in the transponder 1, and does not therefore need to be calculated each time data is to be outputted. This provides the advantage of a simpler transponder 1 that lacks a check sum calculating circuit.

A calculated check sum is calculated in the communicator 4 from data that has been received, and it is compared in the communicator 4 with the received transponder check sum. If the two check sums are not in agreement with one another, the information is considered to have been wrongly transmitted. If the compared check sums are in agreement with one another, all of the transmitted information is considered to have been correctly transmitted.

According to one embodiment of the invention, the calculated check sum is calculated in the communicator 4 on the basis of the information transmitted from the transponder 1, but without including the transmitted transponder check sum in the calculation. According to another embodiment of the invention, the calculated check sum is calculated in the communicator 4 on the basis of both the information transmitted from the transponder 1 and on the basis of the transponder check sum transmitted by the transponder 1. Thus, in this latter embodiment, the transponder check sum transmitted by the transponder 1 is included in the calculation of the calculated check sum in the communicator 4.

The system can be adapted for application in large companies or plants in which several different levels of authorization exist, by using different check-sum calculating algorithms in accordance with the invention, the algorithms giving different check sums for the same data stored in the transponder 1. This procedure can also be applied when wishing to sell the system to several mutually different companies.

The following examples are not intended to limit the scope of the invention, but merely to illustrate different embodiments of the invention.

According to a first specific embodiment of the invention, the information to be stored in the transponder memory is 541 543 518, and the algorithm that calculates the check sum consists in the summation of all the digits. The check sum will thus be 36. The check sum is calculated and stored in the memory of the transponder 3, together with the information 541 543 518, at the time of programming the transponder 1. When the transponder 1 is in the vicinity of the communicator 4, the transponder 1 will receive the inquiry signal 10 and reflect this signal as a modulated signal 11. The reflected and modulated signal 11 is received and interpreted in the communicator 4. The calculated check sum is calculated in the communicator 4 on the basis of the information that has been received from the transponder 1, including information relating to the transponder check sum obtained from the transponder. The calculated check sum is compared in the communicator 4 with the transponder check sum received from the transponder. When the compared check sums disagree, it is considered that the information has been wrongly transmitted. If the compared check sums agree with one another, it is considered that all of the transmitted information has been correctly transmitted.

According to a second embodiment, the transponders are used on ID-tags in a company-installed authority control system. The number of each individual employee is stored in the transponder 1 together with a check sum calculated on the basis of the number of individual employees. In order to enable the authority control system to be used in a company that has several different authority levels, the algorithm used for calculating the calculated check sum is different for each level of authority. Thus, a group of employees provided with ID-tags that are intended to function together with a given algorithm will have authorized access to a specific part of the company. In the case of this embodiment, the algorithm is such that the first 100 employee numbers will have a check sum s, and the next 100 employee numbers will have a check sum s+1, and the next 10 employee numbers will have a check sum s+3, where s is the sum of the digits in the employee number. When reading the information that was stored in the transponder 1, the communicator 4 determines whether or not the individual concerned has authorized access to a department or not, on the basis of the calculated check sum and with the aid of a data system 9.

A third embodiment relates to authority control systems that can be sold to a large number of mutually different companies. The algorithm used for calculating the check sum consists in summing all digits in the employee number. Company A has 1000 different employee numbers divided into three (3) authority levels. The algorithm for calculating the check sum with respect to company A is such that the three different series with employee numbers give the check sums n+498 548 399, n+353 949 988, and n+818 317 802, respectively, where n is the sum of the digits in the employee number. Company B has 100 different employee numbers divided into two (2) levels of authority. The algorithm used for calculating the check sum in respect of company B is such that the check sums for the two levels of authorization are n+113 576 915 and n+918 612 513, respectively, where n is the sum of the digits in the employee number. Company C has 6 employee numbers and only 1 level of authorization. The algorithm used for calculating the check sum of company C is such that the check sum will be n+361 711 918. The possibility of choosing an algorithm for calculating the check sum of a group of employee numbers enables the system to be sold to a very large number of companies, where each company can also have several different algorithms so as to enable several levels of authorization to be included.

According to a fourth embodiment, an identification system is to be sold to a company A. The company A has, among others, three employee numbers 145 916, 145 917, and 145 918. The algorithm for calculating the check sum of company A consists in summing the digits in the employee number and adding 319 514. The check sums obtained with the digits in the employee numbers above are 26, 27, and 28, respectively. The check sums for company A will thus be 319 540, 319 541, and 319 542, respectively.

This identification system is also be sold to another company, designated company B. Company B also has the employee numbers 145 916, 145 917, and 145 918. The algorithm used to calculate the check sum of company B consists in summing the digits in the employee number and adding 418 724. The sums obtained with the digits in the above employee numbers are 26, 27, and 28, respectively. The check sums for company B will thus be 418 750, 418 751, and 418 752, respectively. This procedure enables the system to be sold to many companies while still retaining security.

It is obvious that the check sums and the algorithms can be varied. The person of average skill in this art is able to freely select check sums and algorithms.

The present invention shall not therefore be considered limited to the above-described exemplifying embodiments, since variations can be made within the scope of the accompanying claims.

1: A method relating to identification systems in which a transponder reflects an inquiry signal from a communicator, said method comprising the steps of:
modulating a reflected signal from the transponder with data that can be read by the communicator,
including in said modulated data-carrying signal reflected by the transponder a check sum calculated on the basis of data stored in a memory of the transponder, and
permanently storing the check sum in the transponder memory.

2: A method according to claim, 1, including the step of calculating in the communicator a check sum on the basis of a first algorithm which is identical for a first group of transponders and that is different from an algorithm used for other groups of transponders.

3: A method according to claim 2, wherein the calculation on the basis of the first algorithm takes place in the communicator with each reading of a transponder; and including the step of comparing the calculated check sum with the stored transponder check sum transmitted with the reflected signal

4: A method according to claim 1, wherein the calculation of the check sum in the communicator does not include the transponder check sum transmitted by the transponder.

5: A method according to claim 1, wherein the calculation of the check sum in the communicator includes the transponder check sum transmitted by the transponder.

6: A transponder comprising: at least one antenna, at least one memory, and at least one means for reflecting and modulating an inquiry signal received from a communicator, wherein said reflected signal includes a data-carrying modulation, wherein the reflected signal is read by the communicator, and wherein said data-carrying modulation includes a check sum calculated on the basis of data stored in the transponder memory, wherein the transponder includes a check sum stored permanently in the transponder memory.

7: A transponder according to claim 6, wherein the check sum stored in the transponder is calculated using a first algorithm that is identical for a first group of transponders and that is different from an algorithm used for other groups of transponders.
